(19) United States
(12) Patent Application Publication
(10) Pub. No.: US 2018/0024712 A1
(43) Pub. Date: Jan. 25, 2018

(54) CUSTOMIZED CLOUD BASED ALL IN ONE DASHBOARD

(71) Applicant: Lisa Sievers, San Carlos, CA (US)

(72) Inventor: Lisa Sievers, San Carlos, CA (US)

(21) Appl. No.: 15/423,568

(22) Filed: Feb. 2, 2017

Related U.S. Application Data
(63) Continuation of application No. 62/365,883, filed on Jul. 22, 2016.

(51) Int. Cl. G06F 3/0484; G06F 17/30; G06Q 30/02; H04L 29/06

(52) U.S. Cl. CPC G06F 3/0484; H04L 63/08; G06F 17/30864; G06Q 30/0201; G06F 3/04845; G06F 3/0482

(57) ABSTRACT

The present invention relates to a customized; cloud based all-in-one enterprise dashboard for keeping the key business and personal data at one place. The Dashboard displays all integrated applications and widgets within a single holistic dashboard view.

### CROSS-REFERENCE TO RELATED APPLICATIONS

This application claims the benefit of U.S. Provisional application No. 62/365,883 filed on Jul. 22, 2016.

### BACKGROUND OF INVENTION

### Field of Invention

The present invention relates to a customized, cloud based all-in-one dashboard for keeping the key business and personal data at one place.

### Description of Prior Art

Any discussion of documents, acts, materials, devices, articles or the like which has been included in this specification is solely for the purpose of providing a context for the present invention. It is not to be taken as an admission that any or all of these matters form part of the prior art base or were common general knowledge in the field relevant to the present invention as it existed in United States or elsewhere before the priority date of this application.

Dashboards for enterprise business solutions are in demand today. Businesses want their precious data to be accessed from one place, thus eliminating the hassles of accessing business and social networking data from multiple platforms. Over the period of years, many developers have attempted to formulate such ERP (Enterprise Resource Planning) dashboards but primarily failed to incorporate the best combination of interactive, intelligent business software including banking, accounting and ecommerce applications along with key social media elements. One such example can be seen in U.S. Pat. No. 8,407,576 (2013) to Yin et al. which illustrates web based dashboard with wide array of web pages, digital media components including rich text, media, picture, video widget and any office document. The patent talks about unique Live-area created on demand from any rectangular sub region of web page based on component level visual bookmarking. It however fails to provide interactive and intelligent business software components including financial accounting, ecommerce and banking applications which form the backbone of today's intelligent enterprise business solutions.

Another U.S. Pat. No. 9,003,297 to Pierce (2015) talks about customized and secured dashboard feature integrating internally generated software utilities of an enterprise with external software operating in cloud computing environment. The system primarily deals with operations like data management, communication system, creative processes and social networking communication and enterprise level software data storage. However, so far in the above discussed prior arts no special attention has been given on developing an intelligent enterprise user interface system with essential focus on finance, accounting, marketing and ecommerce based applications, all visible and accessed from a single dashboard within a single holistic view. While the prior arts have attempted to include conventional data storage, data management, data sharing and communication systems in such dashboards as widgets or snippets of code from third-party sites but have hardly contributed to develop a dashboard layout which is easy on the eye and display almost all applications or widgets within a single holistic view. Thus, enhancing the end user experience and user interface ease of use. Moreover, the present invention being a cloud based dashboard eliminates the need to download any updates or softwares and the dashboard can be accessed from any device with an active internet. Hence, the present invention offers convenient GUI layout for end user's ease of use which is an improvement over the existing prior arts in this field.

### SUMMARY OF THE INVENTION

It is an object of the present invention to overcome, or substantially ameliorate, one or more of the disadvantages of the prior art, or to provide a useful alternative.

It is an object of invention to provide an all-in-one, cloud based dashboard with integrated enterprise business applications like accounting, banking, ecommerce, marketing, human resource, inventory and project management along with other applications like social media, email integration, awards, blogs or website entries, all accessed via a single cloud based dashboard from any internet enabled device. The dashboard is also available as a desktop application.

It is yet another object of the present invention to offer a convenient and easy on the eye Graphical User Interface (GUI) layout wherein the applications or widgets can be readily accessed and visible within a single holistic view.

It is an object of present invention to develop a dashboard system that resides in the cloud and can be accessed on multiple devices. The data to be analysed may be accessed from the cloud readily. This data to be analysed is incorporated from various sources, for e.g. Google Analytics®, Twitter®, Instagram®, QuickBooks® and many other utilities.

It is yet another object of present invention to represent various KPI's (Key Performance Indictors) on the dashboard including but not limited to sales metrics, marketing metrics, financial metrics, social media metrics, SEO metrics etc. Businesses tend to use these key details for improving overall performance of their enterprises.

According to an embodiment of the present invention, the dashboard incorporates a convenient custom search bar displaying the internal dashboard based or external web based search results within the same dashboard without having the need to leave the dashboard or opening multiple tabs. The said custom search bar may be a Google®, Yahoo® or Bing® custom search but not limited to that.

According to yet another embodiment of the present invention, the dashboard displays ecommerce sales key metrics (KPIs) including Daily or Weekly sales, average sales, top sales, total orders, new orders, new products, cost of goods, inventory levels etc. and various marketing KPIs including but not limited to website analytics like site traffic, email campaigns, social media followers, page views, time on site etc. All the metrics or data is pulled off from the ecommerce applications (like Shopify®, Amazon®, Ebay®, Bigcommerce® and Woocommerce®) with the help of respective APIs (Application Programming Interface).

According to another embodiment of the present invention, the dashboard displays accounting data and key metrics extracted with the help of Quickbooks® API. The key data and metrics related to the progress of various ongoing or accomplished projects is pulled out with the help of application APIs including but not limited to Basecamp®, Smartsheet®, Mavenink®, Asana® etc.

According to yet another embodiment of the present invention, the dashboard display RSS news feeds of major news networks as selected by the end user within the dashboard user interface.

According to yet another embodiment of the present invention, the dashboard displays a blog application. The user may view recently published blogs and may even compose, delete older and publish new ones straight from the dashboard's blog panel. These blogs can be Blogger® or Wordpress® blog applications but not limited to them.

According to another embodiment, the dashboard incorporated a flexible “To Do” segment wherein the user may keep a track of all ongoing and completed tasks, thus enhancing the end user's business productivity.

The features and advantages of the present invention will become further apparent from the following detailed description of preferred embodiments, provided by way of example only, together with the accompanying drawings.

### BRIEF DESCRIPTION OF DRAWINGS

FIG. 1 illustrates a screenshot of the dashboard with all integral elements and snippets in one single view.

FIG. 2 illustrates another screenshot of user display interface.

FIG. 3 illustrates a screenshot of the user display interface showing integrated email feature.

FIG. 4 illustrates a screenshot of the user interface displaying ecommerce applications

FIG. 5 illustrates a screenshot of the user interface displaying ecommerce APIs.

FIG. 6 illustrates a screenshot of the user interface displaying banking application.

FIG. 7 illustrates a screenshot of the user interface displaying various news feeds.

FIG. 8 illustrates yet another screenshot of the user interface displaying “Tasks” or “To Do” features.

FIG. 9 illustrates a screenshot of the user interface displaying social media applications in a single view.

FIG. 10 illustrates a screenshot of the user interface displaying an ecommerce dashboard.

FIG. 11 illustrates a screenshot of the user interface displaying Human Resource dashboard.

FIG. 12 illustrates a screenshot of the user interface displaying Accounts dashboard.

FIG. 13 illustrates a screenshot of the user interface displaying Marketing dashboard

### DETAILED DESCRIPTION OF PREFERRED EMBODIMENTS

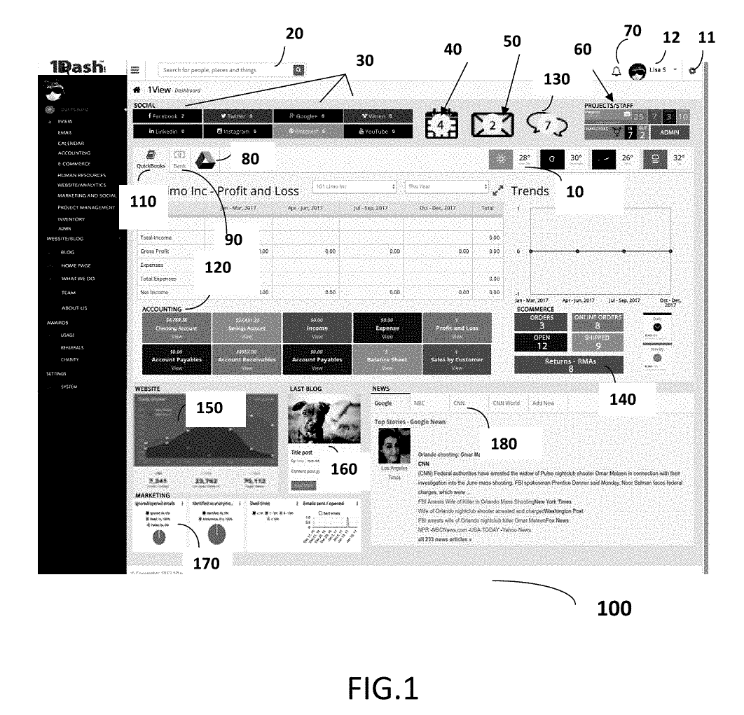

FIG. 1 illustrates a screenshot 100 of the dashboard with all integral elements and snippets in a single view. These elements in the dashboard include social media applications 30 incuding Facebook®, Linkedin®, Vimeo®, Twitter®, Instagram®, Youtube®, Pininterest®, Google®, email 50, calendar 40, user profile 12, notifications 70, chat 130, project or staff details 60, e-commerce analytics 140, accounting analytics 120, Quickbooks® 110, Google® Drive 80, Banking 90, Temperature 10, website analytics 150, blog panel 160, news feeds 180 and marketing analytics 170, custom search bar 20 which displays Google® search results within the dashboard without having the need to leave the dashboard or opening multiple tabs. The dashboard display theme or colour can be customised through settings 11.

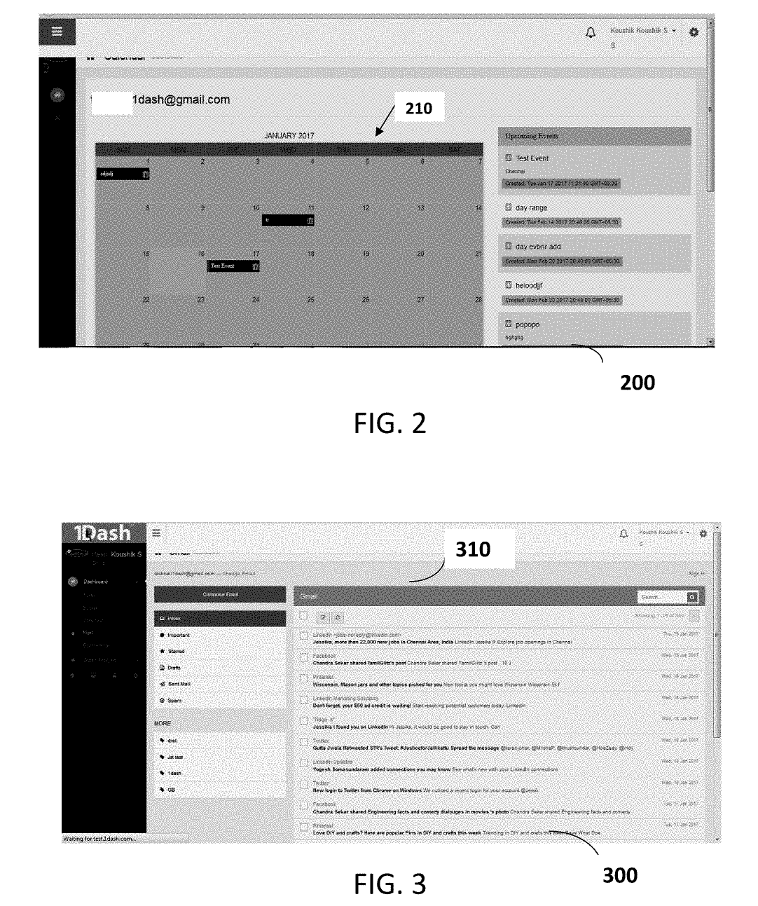

FIG. 2 illustrates a screenshot 200 of the dashboard with Google Calendar 210. The user can create custom Google® Calendar by retrieving metrics directly from their Google accounts.

FIG. 3 illustrates a screenshot 300 with integrated Gmail® feature 310. The system directly retrieves and syncs the mail data from the user's Google account. The user may connect multiple Gmail® accounts to the dashboard and may read, compose and send email messages from the said dashboard interface.

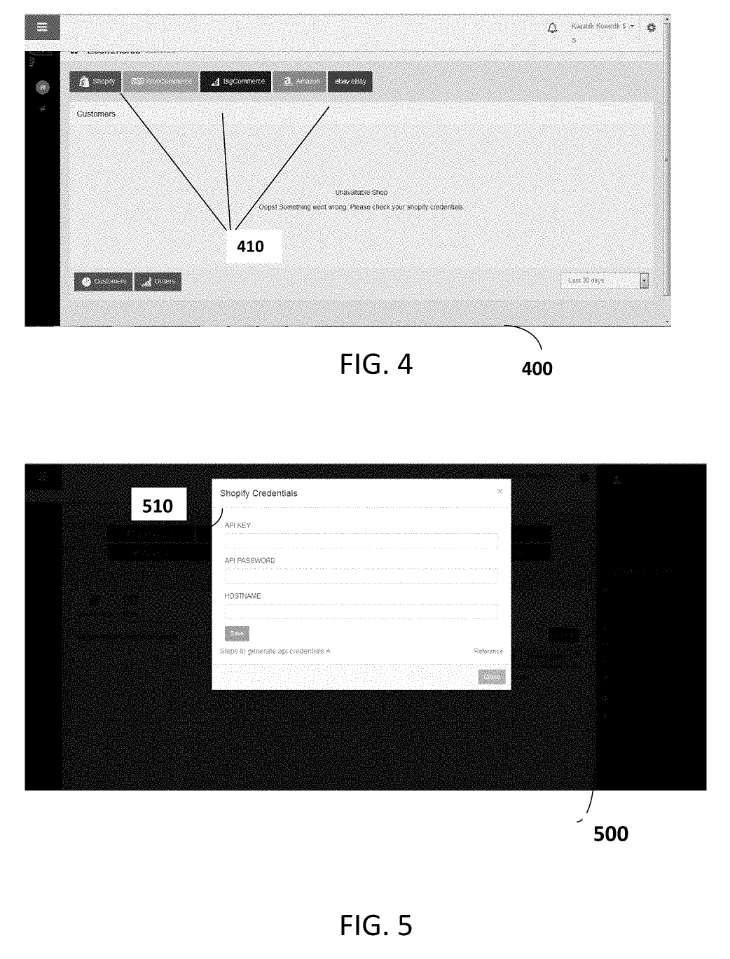

FIG. 4 illustrates a screenshot 400 of the user interface displaying ecommerce applications 410 including Shopify®, Amazon®, Ebay®, Bigcommerce® and Woocommerce®. All the metrics or data is pulled off from the ecommerce applications with the help of respective APIs and represented on the dashboard.

FIG. 5 illustrates a screenshot 500 displaying verification of the credentials of one of the ecommerce applications Shopify® 510. This includes entering API key, password and hostname.

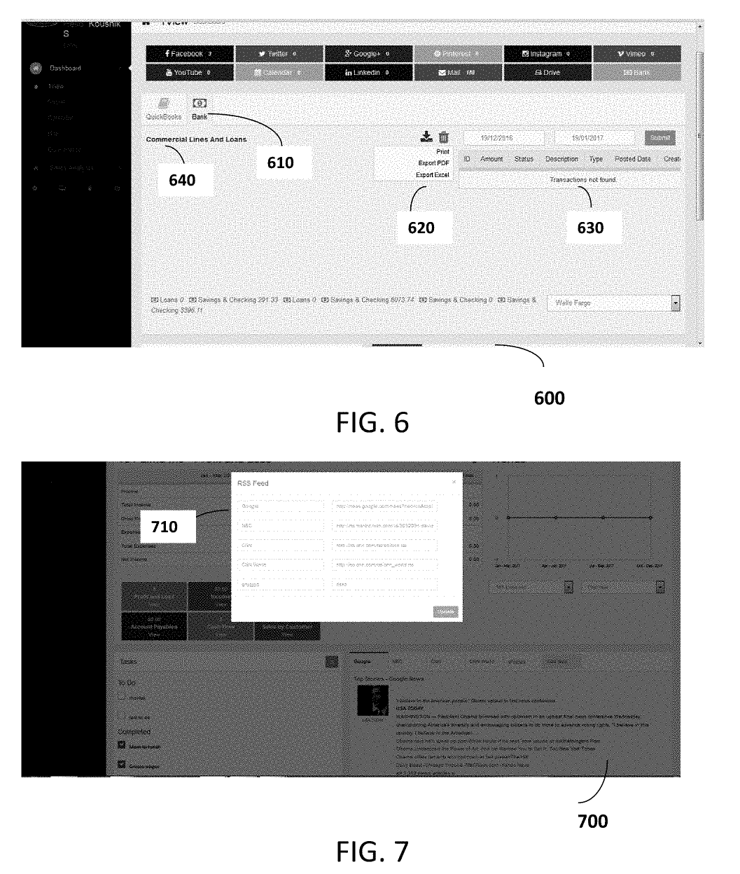

FIG. 6 illustrates a screenshot 600 displaying Banking menu 610. The dashboard displays details like Transactions on specific dates 630, Loans data 640 etc. The user may also download, print or Export PDF or Excel data 620 pertaining to the transactions.

FIG. 7 illustrates a screenshot 700 displaying syndicated news content as RSS Feeds The RSS feeds allows the end user to easily stay informed by retrieving the latest news content from the news sites of interest.

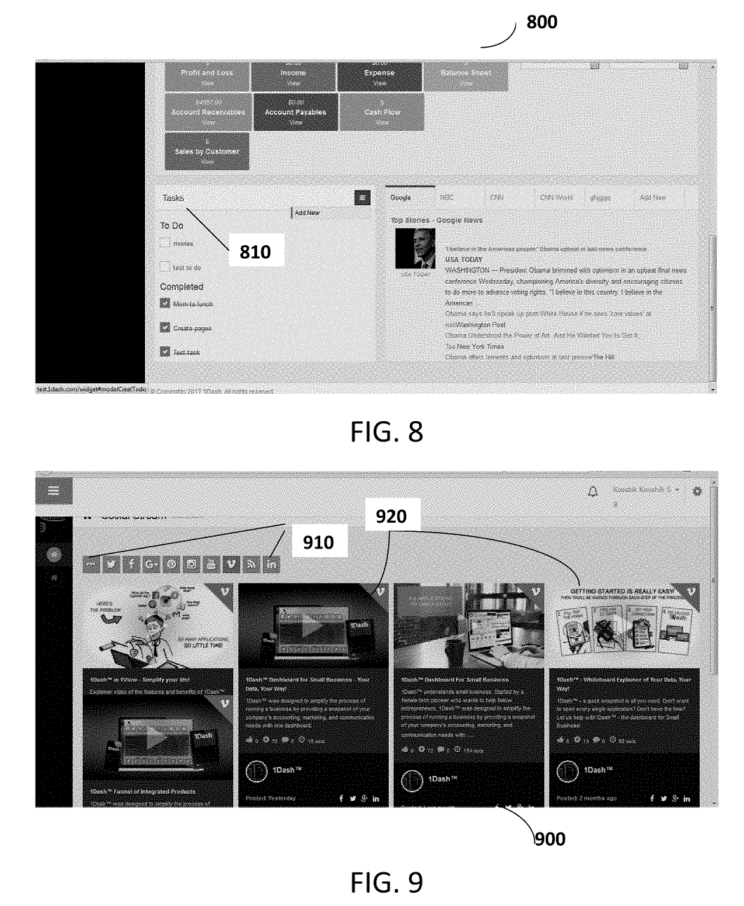

FIG. 8 illustrates a screenshot 800 displaying the “Tasks” menu 810. The user may add various ‘to do’ tasks and ‘completed tasks’ under this menu.

FIG. 9 illustrates a screenshot 900 displaying user interface with all social media applications 910 in a single view including Facebook®, Linkedin®, Vimeo®, Twitter®, Instagram®, Youtube®, Pininterest®. The user may select any social media application say Vimeo® and the corresponding application's widgets 920 get displayed on the dashboard showing the relevant contents of the social media application selected.

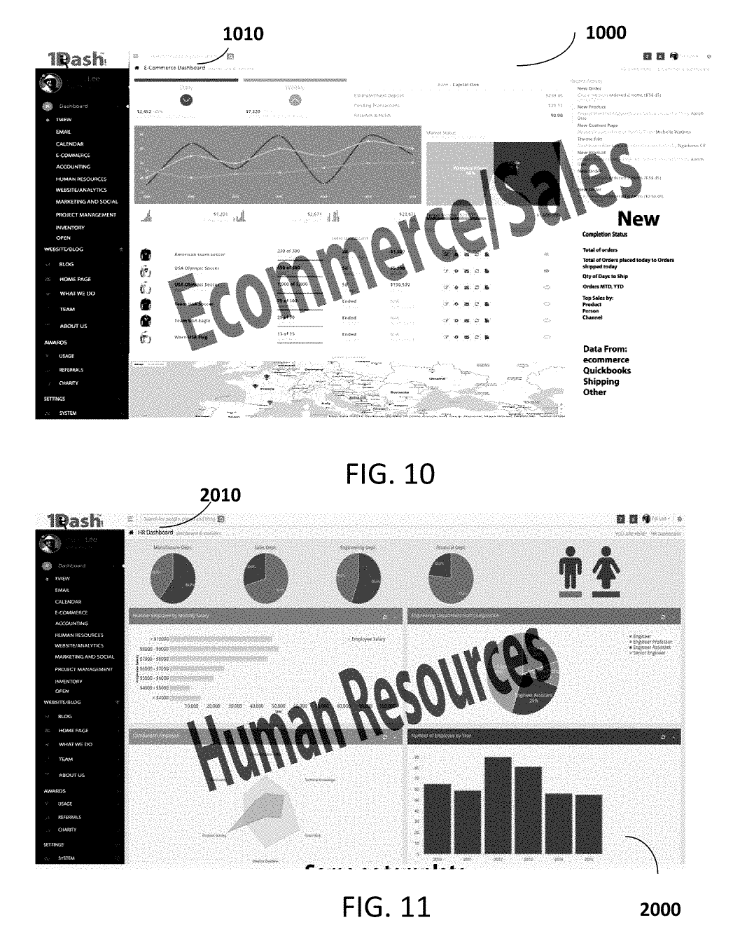

FIG. 10 illustrates a screenshot 1000 pertaining to ecommerce menu. The screenshot 1000 displays the ecommerce dashboard 1010 showing ecommerce sales key metrics (KPIs) including daily or Weekly sales, average sales, top sales, total orders, new orders, new products, cost of goods and inventory levels etc.

FIG. 11 illustrates a screenshot 2000 pertaining to Human Resource menu. The screenshot 2000 displays the Human Resource dashboard 1010 showing HR key metrics (KPIs) including employee salaries, departments, number of employees, staff composition, employee comparison, etc.

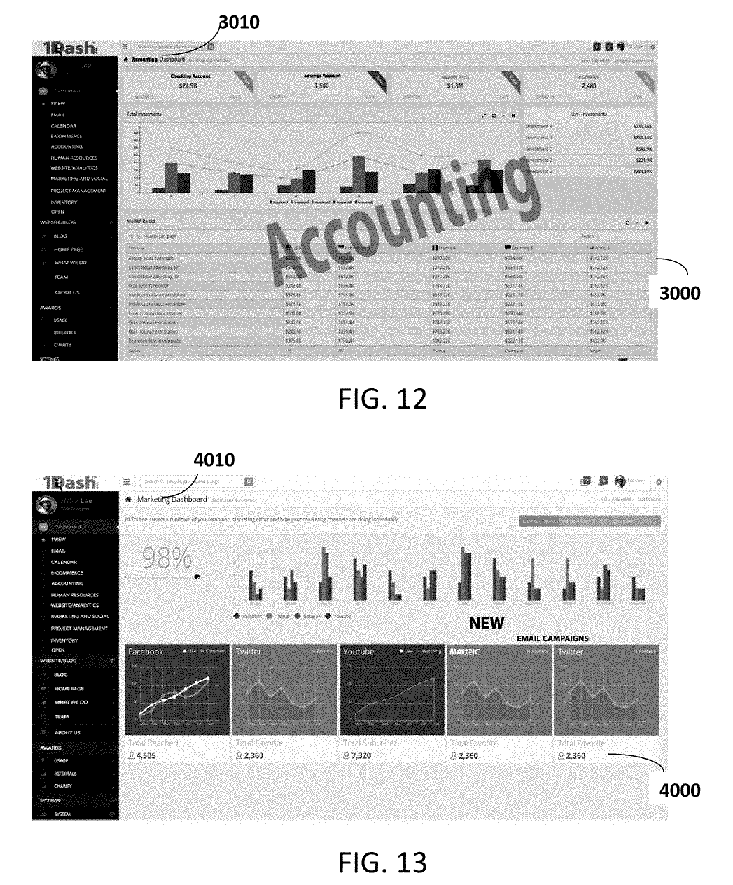

FIG. 12 illustrates a screenshot 3000 pertaining to Accounting menu. The screenshot 3000 displays the Accounting dashboard 3010 showing Accounting key metrics (KPIs) including total investments, saving accounts, start up expenses, median raised etc.

FIG. 13 illustrates a screenshot 4000 pertaining to Marketing menu. The screenshot 4000 displays the Marketing dashboard 4010 showing marketing key metrics (KPIs) including website analytics like site traffic, email campaigns, social media followers, page views, time on site etc.

While a number of preferred embodiments have been described, it will be appreciated by persons skilled in the art that numerous variations and/or modifications may be made to the invention without departing from the spirit or scope of the invention as broadly described. The present embodiments are, therefore, to be considered in all respects as illustrative and not restrictive.

What is claimed is:

1. A user friendly all-in-one Enterprise Dashboard wherein all the integrated applications and widgets can be readily accessed and visible within a single holistic dashboard view.

2. A user friendly all-in-one Enterprise Dashboard as claimed in claim 1 comprising;
accounting, marketing, ecommerce and human resource dashboard segments;
said dashboard segments display key metrics or key performance indicators (KPIs) on the said dashboard interface;
said key metrics are pulled off from APIs (Application programming interface) of third party ecommerce, marketing, human resource, accounting applications and displayed within the said dashboard interface.

3. A user friendly all-in-one Enterprise Dashboard as claimed in claim 2 comprising;
integrated blog application, social media applications and email application;
said blog application uses API of major blog services including but not limited to Blogger®, Wordpress® etc. to create and publish new blog posts, edit or delete existing post right from the said dashboard interface;
said email application extracts mailbox data like drafts, history, threads, and messages from the APIs of major email providers including but not limited to Gmail® Yahoomail®, Hotmail® etc and said email application allows to read, compose and send email messages from the said dashboard interface.

4. An Enterprise Dashboard as claimed in claim 2, wherein the said dashboard interface displays RSS news feeds of various news providers as selected by the said user.

5. An Enterprise Dashboard as claimed in claim 2 comprising custom search bar; said search bar displays the dashboard's internal search results and external web based search results within the dashboard's interface without actually leaving the said dashboard.

6. An Enterprise Dashboard as claimed in claim 2, wherein the overall theme and color of the said dashboard interface may be customized as per user preference.

7. An Enterprise Dashboard as claimed in claim 2, wherein the said dashboard's functionalities may be accessed by the authenticated users through cloud computing;
said authenticated user details are stored in the dashboard's user profile area.

8. An Enterprise Dashboard as claimed in claim 7, wherein the said dashboard's functionalities may be accessed by the authenticated users through a desktop application.

9. An Enterprise Dashboard as claimed in claim 2, wherein the said applications and utilities can be readily seen within a single holistic dashboard view.
